(19) United States
(12) Patent Application Publication
(10) Pub. No.: US 2023/0234552 A1
(43) Pub. Date: Jul. 27, 2023

(54) SYSTEM FOR TRACKING MODE OF OPERATION IN HYBRID ELECTRIC VEHICLES

(71) Applicant: Green Tiger Mobility Private Limited, Bengaluru (IN)

(72) Inventors: Ashish Dokania, Bangalore (IN); Aditya Ganjapure, Nagpur (IN); Mahendra Sengar, Bengaluru (IN); Sourabh Tiwary, Varanasi (IN)

(73) Assignee: Green Tiger Mobility Private Limited, Bengaluru (IN)

(21) Appl. No.: 18/102,493

(22) Filed: Jan. 27, 2023

(30) Foreign Application Priority Data
Jan. 27, 2022 (IN) 202241004556

(51) Int. Cl. B60W 20/00; B60W 50/04; B60W 10/26; B60W 10/30

(52) U.S. Cl. CPC B60W 20/00; B60W 50/045; B60W 10/26; B60W 10/30; B60W 2556/45; B60W 2510/242

(57) ABSTRACT

A wiring harness design for Hybrid electric vehicles (HEV) or Dual Power vehicles that uses a wiring harness that is operatively coupled to a cloud connected motor controller that detects mode of operation in two-wheelers and continuously transmit telemetry data to a cloud server.

### CROSS-REFERENCE TO RELATED APPLICATION(S)

This application claims priority to Indian Patent Application No. 202241004556 filed on Jan. 27, 2022, the complete disclosure of which, in its entirety, is hereby incorporated by reference.

### TECHNICAL FIELD

The present disclosure relates to data collection from hybrid electric vehicles. In particular, the present disclosure relates to cloud connected motor controller that detects mode of operation in two-wheelers and continuously transmit telemetry data to a cloud server.

### BACKGROUND

Background description includes information that may be useful in understanding the present invention. It is not an admission that any of the information provided herein is prior art or relevant to the presently claimed invention, or that any publication specifically or implicitly referenced is prior art.

A tectonic shift is taking place in the hybrid electric vehicle (HEV) industry. Changes in technology, consumer behavior, and emerging markets are disrupting traditional modes of operation. Today's vehicles are more sophisticated and complex. In the last twenty years, the development of HEVs and electric vehicles (EVs) has been accelerated for the purpose of improving fuel efficiency and reducing CO₂ emissions to prevent global warming and depletion of fossil fuels. In particular, HEVs have spread rapidly because existing gasoline service stations can be used for refueling. Typically, hybrid electric vehicles are vehicles that are powered, at least to some extent, using electric power or that have limited use of conventional Internal Combustion (IC) energy sources. Hybrid vehicles are generally defined by their powertrain layout and the extent to which the electric motor affects energy consumption.

There are many electronics, software, and online connectivity all posing a new service, security, and privacy challenges and opportunities of HEVs. Typically, there can be 500+ data signals that are generated from a connected vehicle. Hence, there is a difference in the data provided by each source pertaining to number of collected signals, format and frequency of distributed data. Based on the industry and associated use cases, data consumers are interested to consume specific data signals at a particular frequency. In dual powertrain vehicle, motor controller runs of EV powertrain battery, so it is easy to track details and get data when vehicle is running on the EV mode. But getting data when vehicle is running on the petrol mode is very difficult.

Therefore, there is a requirement of an improved system that can overcome aforementioned problems and challenges in the art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### OBJECTS OF THE PRESENT DISCLOSURE

Some of the objects of the present disclosure aimed to ameliorate one or more problems of the prior art or to at least provide a useful alternative are listed herein below:

An object of the present disclosure is to provide a system that detects the vehicle mode of operation and clog the data of the parameters in each individual mode.

An object of the present disclosure is to provide a completely new wire harness with switching circuitries to take the battery output from existing lead acid batteries.

### SUMMARY

The present disclosure relates to wiring harness design for Hybrid or Dual Power vehicles. More particularly to a system/method for efficient, easy to assemble, and cost-effective wiring harness design for Hybrid or Dual Power vehicles.

In an aspect, the present disclosure the provides for a system for tracking mode of operation in a hybrid electrical vehicle (HEV). The system may include an Internal Combustion (IC) engine, a battery, a wiring harness and a control unit. The IC engine may be electrically coupled to an Ignition lock configured to control an Ignition mode of the HEV. Further, the battery may be operatively coupled to a predefined supply unit, and further connected to a relay that may actuate the predefined supply to a DC-DC converter and a controller for actuating an electrical vehicle (EV) mode of the HEV. The wiring harness may be electrically coupled to an auxiliary system associated with the HEV and may include a switching system, such that the wiring harness connects the auxiliary system to the Ignition lock to extract a first signal from the battery. Further, the control unit may be operatively coupled to a hub motor. The control unit comprises a processor coupled with a memory, wherein the memory stores instructions which when executed by the processor causes the control unit to: receive, the first signal from the auxiliary system, wherein the first signal pertain to a predefined voltage; extract, a first set of attributes from the first signal received, said first set of attributes pertaining to an ON status of the Ignition mode; extract, a second set of attributes, said second set of attributes pertain to an ON status of the EV mode; compare, the first and the second set of attributes extracted to determine whether the HEV is running in the Ignition mode or the EV mode at any time; and acquire, a set of automotive signals from the HEV irrespective of the EV mode or the Ignition mode.

In an aspect, the switching system may be electrically connected with the Ignition Lock and the relay, wherein the switching system comprises any or a combination of double pole double throw (DPDT) and a single pole double throw (SPDT) switch.

In an aspect, the auxiliary system may include one or more headlights, one or more dashboard lights and one or more tail lamps.

In an aspect, the HEV nay be two wheelers or three wheeler HEVs.

In an aspect, the first signal may also be used to charge a second battery associated with the control unit. The second battery may further be used to power a GPS such that the second battery can charge in both modes of operation.

In an aspect, the control unit may directly track the EV mode.

In an aspect, the set of automotive signals acquired by the control unit may be transmitted to a computing device to be stored in a server through any wired or wireless network.

In an aspect, the battery may be a lead acid battery.

In an aspect, in the EV mode, a 12V lead acid input may be taken from out of the Ignition lock and provided to the auxiliary system of the HEV.

In an aspect, in the IC mode power is taken from the lead acid battery and a dynamo and provided to the auxiliary system of the HEV.

### BRIEF DESCRIPTION OF THE DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1A illustrate exemplary representation of the proposed system in accordance with embodiments of the present disclosure.

FIG. 1B that illustrates an exemplary network architecture in which or with which the control unit of the present disclosure can be implemented, in accordance with an embodiment of the present disclosure.

FIG. 2 illustrates an exemplary representation of the control unit, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Embodiments of the present disclosure relate to a wiring harness design for Hybrid electric vehicles (HEV) or Dual Power vehicles that relates to a cloud connected motor controller that detects mode of operation in two-wheelers and continuously transmit telemetry data to a cloud server.

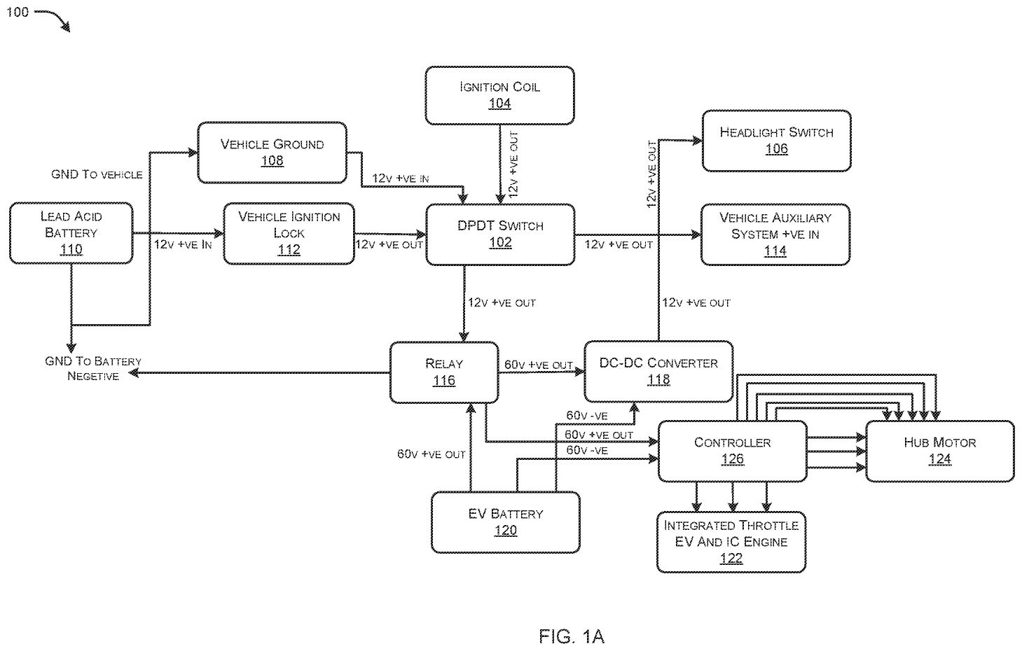

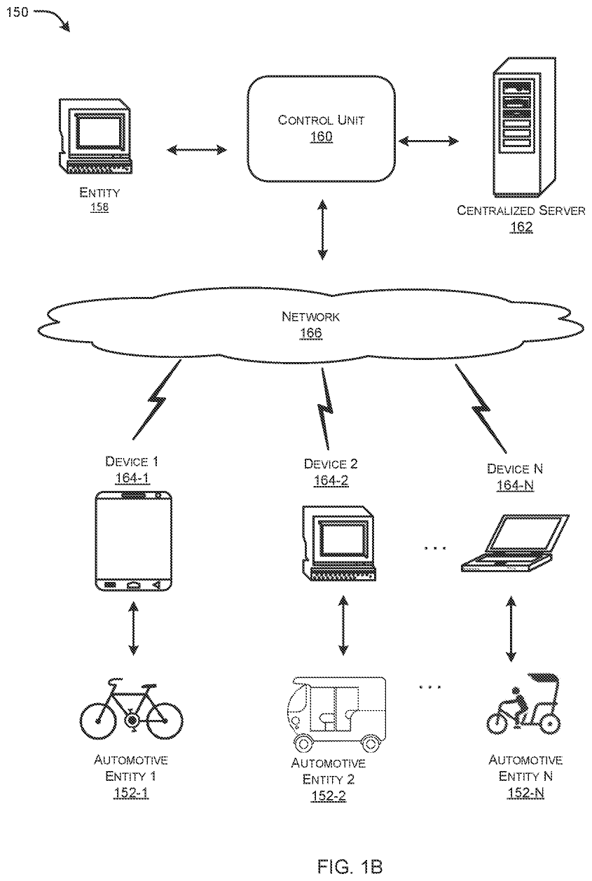

Referring to FIG. 1A, the present disclosure provides for a system (100) for tracking mode of operation in a hybrid electrical vehicle (HEV) and may include an Internal Combustion (IC) engine (104) electrically coupled to an Ignition lock (162) that may control an Ignition mode of the HEV. The system (100) can include a battery (110) operatively coupled to a predefined supply unit. In an exemplary embodiment, the battery can be a lead acid battery but not limited to the like. The lead acid battery can be connected to a relay (116) that actuates the predefined supply to a DC-DC converter (118) and a controller (126) for actuating an electrical vehicle (EV) mode of the HEV.

The system (100) further includes a wiring harness that includes a switching system (102). The switching system (102) can be a double pole double throw (DPDT) or a single pole double throw (SPDT) switch. The DPDT/SPDT switch can be connected in series with the ignition lock of the HEV and can disconnect a first wiring harness connected to the Ignition Lock (162) to isolate the functioning of the IC mode and then trigger the lead acid battery (110) operatively coupled to a predefined supply unit such that the relay actuates the predefined supply unit such as a 12V supply but not limited to it to the DC-DC converter and the controller for actuating the EV mode of the HEV. The DPDT/SPDT switch can switch on the IC engine directly and disconnect a second wiring harness to the relay (116) when the HEV is in the Ignition mode to isolate the functioning of the EV mode. Accordingly, an electrical drive/motor (124) will turn off when the ignition switch is turned off by using the DPDT/SPDT switch and it isolates the functioning of the two powertrains.

Referring to FIG. 1B that illustrates an exemplary network architecture (150) in which or with which a vehicle control unit (VCU) (160) (or simply referred to as the control unit (160) hereinafter) of the present disclosure can be implemented, in accordance with an embodiment of the present disclosure. As illustrated, the exemplary architecture (150) includes a control unit (160) operatively coupled to one or more computing devices (154) associated with plurality of HEVs (152-1, 152, . . . 152-N) (collectively referred to as HEV (152) and individually referred to as HEV (152) to be stored in one or more computing devices (168) associated with an entity.

The control unit (160) may be coupled to a centralized server (162). The control unit (160) may also be operatively coupled to the one or more computing devices (104) and through a network (166).

Further, the network (166) can be a wireless network, a wired network, a cloud or a combination thereof that can be implemented as one of the different types of networks, such as Intranet, BLUETOOTH, MQTT Broker cloud, Local Area Network (LAN), Wide Area Network (WAN), Internet, and the like. Further, the network 106 can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), and the like. In an exemplary embodiment, the network 104 can be an HC-05 Bluetooth module which is an easy to use Bluetooth SPP (Serial Port Protocol) module, designed for transparent wireless serial connection setup.

In an embodiment, the control unit (160) may be further operatively associated with the controller (126) and a hub motor of the HEV (152). The control unit (160) may include a processor coupled with a memory, wherein the memory stores instructions which when executed by the processor (202) (Ref. FIG. B) causes the control unit (160) to: receive, the first signal from the auxiliary system, wherein the first signal pertain to a predefined voltage. The control unit may extract, a first set of attributes from the first signal received, the first set of attributes pertaining to an ON status of the Ignition mode and further extract, a second set of attributes pertaining to an ON status of the EV mode. The control unit (160) may then compare, the first and the second set of attributes extracted to determine whether the HEV is running in the Ignition mode or the EV mode at any time. In an exemplary embodiment, the control unit (160) can acquire, a set of automotive signals from the HEV irrespective of the EV mode or the Ignition mode.

In an exemplary embodiment, the set of automotive signals can be associated with but not limited to telemetry data of the HEV (152).

In an aspect, the first signal may also be used to charge a second battery associated with the control unit. The second battery may further be used to power a GPS such that the second battery can charge in both modes of operation. In an exemplary embodiment, the control unit may directly track the EV mode.

In an exemplary embodiment, the headlight, dashboard light and the tail lamp switching happens with a headlight switch (106) on. The headlight switch has 12V positive in supply, the 12V positive in is given from DC-DC output in EV mode and directly from lead acid battery in IC engine mode.

In an exemplary implementation, as a way of example and not as a limitation, in order to track the mode of operation a 12V supply can be given to the auxiliary system of the HEV in both the ICE and the EV mode. The first signal can be but not limited to a 12V signal to the controller to sense the running of the system (100). The 12V supply is ON when the Ignition key is ON. The 12V signal can also used to charge the VCU battery used to power the GPS so the VCU battery can charge in both modes of operation. When EV mode is ON the EV battery operation is tracked directly, whereas the signal helps track the ON status of EC engine also. Making the tracking of vehicle run in IC engine and EV mode separately possible.

In an exemplary embodiment, the HEV can be two wheelers or three wheeler HEVs but not limited to the like.

In an exemplary embodiment, the IC mode or EV mode (interchangeably referred to as power trains) run independently. THE HEV can purely work on EV as well as IC mode.

In an embodiment, the one or more computing devices (164), may communicate with the control unit (160) via set of executable instructions residing on any operating system, including but not limited to, Android™, iOS™, Kai OS, TM Linux, Android Auto, QNX and the like. In an embodiment, to one or more computing devices (164) may include, but not limited to, any electrical, electronic, electro-mechanical or an equipment or a combination of one or more of the above devices such as mobile phone, smartphone, virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen, receiving devices for receiving any audio or visual signal in any range of frequencies and transmitting devices that can transmit any audio or visual signal in any range of frequencies. It may be appreciated that the to one or more first computing devices (164) may not be restricted to the mentioned devices and various other devices may be used. A smart computing device may be one of the appropriate systems for storing data and other private/sensitive information.

In an embodiment, the control unit (160) or the centralized server (162) may include one or more processors (202) coupled with a memory (206), wherein the memory may store instructions which when executed by the one or more processors may cause the system to access content stored in the network (166).

In another exemplary embodiment, the centralized server (162) may include or comprise, by way of example but not limitation, one or more of: a cloud based server, a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof.

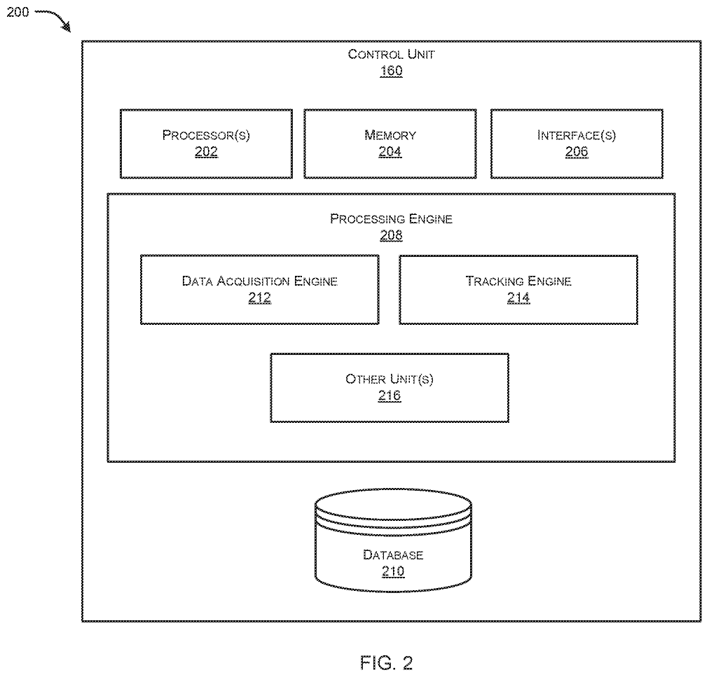

FIG. 2 with reference to FIG. 1, illustrates an exemplary representation of control unit (160)/centralized server (162) for facilitating real time automotive data feeds, in accordance with an embodiment of the present disclosure. In an aspect, the control unit (160)/centralized server (162) may comprise one or more processor(s) (202). The one or more processor(s) (202) may be implemented as one or more microprocessors, microcomputers, microcontrollers, cloud-based processors, digital signal processors, central processing units, logic circuitries, and/or any devices that process data based on operational instructions. Among other capabilities, the one or more processor(s) (202) may be configured to fetch and execute computer-readable instructions stored in a memory (206) of the control unit (160). The memory (206) may be configured to store one or more computer-readable instructions or routines in a non-transitory computer readable storage medium, which may be fetched and executed to create or share data packets over a network service. The memory (206) may comprise any non-transitory storage device including, for example, volatile memory such as RAM, or non-volatile memory such as EPROM, flash memory, and the like.

In an embodiment, the control unit (160)/centralized server (162) may include an interface(s) 204. The interface(s) 204 may comprise a variety of interfaces, for example, interfaces for data input and output devices, referred to as I/O devices, storage devices, and the like. The interface(s) 204 may facilitate communication of the control unit (160). The interface(s) 204 may also provide a communication pathway for one or more components of the control unit (160) or the centralized server (162). Examples of such components include, but are not limited to, processing engine(s) 208 and a database 210.

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the control unit (160)/centralized server (162) may comprise the machine-readable storage medium storing the instructions and the processing resource to execute the instructions, or the machine-readable storage medium may be separate but accessible to the control unit (160)/centralized server (162) and the processing resource. In other examples, the processing engine(s) (208) may be implemented by electronic circuitry.

The processing engine (208) may include one or more engines selected from any of a data acquisition engine (212), a tracking engine (214), and other engines (216).

Thus, the present disclosure provides for a unique and efficient system that facilitates an arrangement via which the motor controller can run via existing lead acid battery of the vehicle. So, in this case it will detect the operation happening from ICE mode also.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides for a system that makes assembly of Hybrid Electric two wheels and three wheels easy.

The present disclosure provides for a system that detects the vehicle mode of operation and clog the data of the parameters in each individual mode.

The present disclosure provides for a completely new wire harness with switching circuitries to take the battery output from existing lead acid batteries.

What is claimed is:

1. A system for tracking mode of operation in a hybrid electrical vehicle (HEV), said system comprising:
an internal combustion (IC) engine, said IC engine electrically coupled to an ignition lock, said ignition lock configured to control an ignition mode of the HEV;
a battery operatively coupled to a predefined supply unit, wherein the battery is connected to a relay for actuating an electrical vehicle (EV) mode of the HEV;
a wiring harness electrically coupled to an auxiliary system associated with the HEV, said wiring harness comprising a switching system, such that the wiring harness connects the auxiliary system to the ignition lock to extract a first signal from the battery; and
a control unit operatively coupled to a hub motor, wherein the control unit comprises a processor coupled with a memory, wherein said memory stores instructions which when executed by the processor causes the controller to:
receive the first signal from the auxiliary system, wherein the first signal pertain to a predefined voltage;
extract a first set of attributes from the first signal received, said first set of attributes pertaining to an ON status of the ignition mode;
extract a second set of attributes, said second set of attributes pertain to an ON status of the EV mode;
compare the first and the second set of attributes extracted to determine whether the HEV is running in the ignition mode or the EV mode at any time; and
acquire a set of automotive signals from the HEV irrespective of the EV mode or the ignition mode.

2. The system as claimed in claim 1, wherein said switching system is electrically connected with the ignition lock and the relay, wherein the switching system comprises any or a combination of double pole double throw (DPDT) and a single pole double throw (SPDT) switch.

3. The system as claimed in claim 1, wherein the auxiliary system comprises one or more headlights, one or more dashboard lights, and one or more tail lamps.

4. The system as claimed in claim 1, wherein the HEV are two wheelers or three wheeler HEVs.

5. The system as claimed in claim 1, wherein the first signal is also used to charge a second battery associated with the control unit, and wherein the second battery is used to power a global positioning system (GPS) such that the second battery charges in both modes of operation.

6. The system as claimed in claim 1, wherein the control unit directly tracks the EV mode.

7. The system as claimed in claim 1, wherein the set of automotive signals acquired by the control unit is transmitted to a computing device to be stored in a server through any wired or wireless network.

8. The system as claimed in claim 1, wherein the battery is a lead acid battery.

9. The system as claimed in claim 1, wherein in the EV mode, a 12V lead acid input is taken from out of the ignition lock and provided to the auxiliary system of the HEV.

10. The system as claimed in claim 1, wherein in the IC mode power is taken from the lead acid battery and a dynamo and provided to the auxiliary system of the HEV.
